(19) United States
(12) Patent Application Publication
(10) Pub. No.: US 2020/0317385 A1
(43) Pub. Date: Oct. 8, 2020

(54) SYSTEMS AND METHODS FOR PROVIDING THE APPLICATION OF LABELS TO HIGH TEMPERATURE MATERIALS

(71) Applicant: FLEXcon Company, Inc., Spencer, MA (US)

(72) Inventors: Ronald Ducharme, Dudley, MA (US); Edward L. Prinsen, II, West Brookfield, MA (US)

(21) Appl. No.: 16/839,622

(22) Filed: Apr. 3, 2020

Related U.S. Application Data
(60) Provisional application No. 62/828,775, filed on Apr. 3, 2019.

(51) Int. Cl. B65C 9/26

(52) U.S. Cl. CPC B65C 9/26

(57) ABSTRACT

A label applicator is disclosed for use in attaching a high temperature resistant label to substrates at temperatures of at least 350° C. The label applicator includes an extension member attached to a label containment area, the label containment area including at least one edge restraint for retaining the label and a backing area that includes a surface with a low specific energy that inhibits adhesion of a printed side of the label to the backing area of the containment area.

### PRIORITY

The present application claims priority to U.S. Provisional Patent Application Ser. No. 62/828,775 filed Apr. 3, 2019, the disclosure of which is hereby incorporated by reference in its entirety.

### BACKGROUND

The invention generally relates to labels and labeling, and relates in particular to the labeling of products prior to cooling where the products are manufactured at high temperatures.

The labeling of products as the products are manufactured is essential in many industries for purposes of inventory control and asset management. If manufactured product is not labeled immediately following production, the identity of the product and details regarding its manufacture may be lost, particularly during high volume production. The sooner an item is labeled with regard to its type, grade, lot or batch, date of manufacturer, etc. the less likely that a misidentification of the item will occur. The misidentification of inventory materials may lead to serious consequences, such as increased waste in raw materials and the potential for product failures. Inventory labeling immediately following manufacture has therefore become an integral part of business today in maintaining proper quality traceability and inventory expenses.

Current high temperature labels (or tags) consist of a pre-printed or otherwise inscribed plate made of ceramic or metal that is mechanically fastened to the hot object to be labeled. This may require that rivets or other fastening devices be set into the product, potentially damaging a portion of the product. This may also be unsafe for the personnel whose job it is, to apply the label to the hot product.

Current processes for identifying hot metals also include the use chalk or paint, as well as the use of a nail gun to fashion a metal plate to the hot steel. The chalk and paint system can either wash off with water (e.g., rain) leaving the product without identity, or the paint can run creating a false identity. The use of a nail gun requires bringing the employee into very close proximity to the very hot steel creating a potential hazard. In either case the hot metal may be placed aside waiting for the product cool down enough to apply a standard label material. Unfortunately, during this time the metal cannot be sold or in an extreme case may be misplaced and the identity may be lost. Such a product cannot be sold until the product is fully identified.

There remains a need therefore, for a label and a method of labeling of products at elevated temperatures.

### SUMMARY

In accordance with an aspect, the invention provides a label applicator for use in attaching a high temperature resistant label to substrates at temperatures of 350° C. to 1000° C. The label applicator includes an extension member attached to a label containment area, and the label containment area includes at least one edge restraint for retaining the label and a backing area that includes a surface with a low specific energy that inhibits adhesion of a printed side of the label to the backing area of the containment area.

In accordance with another aspect, the invention provides a label applicator for use in attaching a high temperature resistant label to substrates at temperatures of at least 350° C. The label applicator includes an extension member attached to a label containment area, and the label containment area includes least one vacuum opening through which a vacuum may be provided to facilitate maintaining the label in the label containment area and a backing area that includes a surface with a low specific energy that inhibits adhesion of a printed side of the label to the backing area of the containment area.

In accordance with a further aspect, the invention provides a method of attaching a high temperature resistant label to substrates at a temperature of at least 350° C. The method includes retaining the high temperature resistant label within a label containment area of a label applicator, extending the label applicator to a high temperature substrate, adhering the high temperature resistant label to the high temperature substrate, and releasing the high temperature label from the label applicator.

### BRIEF DESCRIPTION OF THE DRAWINGS

The following description may be further understood with reference to the accompanying drawings in which:

FIGS. 1A and 1B show illustrative diagrammatic sectional views of a label applicator in accordance with as aspect of the invention (FIG. 1A) as well as an enlarged view of a portion of the label applicator with an edge restraint shown in the open position (FIG. 1B);

FIGS. 2A and 2B show illustrative diagrammatic views of a label applicator in accordance with a further aspect of the invention that includes a vacuum line (shown in the sectional view of FIG. 2A) that is provided through apertures (shown in FIG. 2B);

FIGS. 3A-3C show illustrative diagrammatic views of label applicators in accordance with further aspects of the invention that include a shaped crown (FIG. 3A), and an inflatable bladder shown not inflated (FIG. 3B) and inflated (FIG. 3C);

FIG. 4 shows an illustrative side sectional view of a label applicator in accordance with an aspect of the invention;

FIG. 5 shows an illustrative diagrammatic isometric view of the label applicator of FIG. 4;

FIG. 6 shows an illustrative diagrammatic view of the label applicator of FIG. 4 showing the extension handle;

FIG. 7 shows an illustrative diagrammatic side view of the label applicator of FIG. 6;

FIG. 8 shows an illustrative diagrammatic end view of the label applicator of FIG. 6;

FIG. 9 shows an illustrative diagrammatic bottom view of the label applicator of FIG. 6; and

FIG. 10 shows an illustrative diagrammatic isometric view of a label applicator in accordance with a further aspect of the invention that includes an automated actuator.

The drawings are shown for illustrative purposes only.

### DETAILED DESCRIPTION

In accordance with an embodiment, the invention provides a powered label applicator that applies a label to high temperature surfaces without burning and without the label applicator sticking to the label material. By using this process, the hot product may be identified as close to the hot zone as possible allowing the proper tracking of the asset. The applicator also provides that the operator may be kept a safe distance from the hot product. Additionally, because of the temperatures of the application site, the applicator may be used to eliminate the oxygen in the application area eliminating the potential for a flare up, as well as providing additional safety precautions. The applicator may also be set-up so that the operator may be positioned a safe distance from the hot application site. In accordance with an aspect, the applicator and printer provide an automated process eliminating the need for any operator from being in a danger zone.

There is considerable value in attaching an identifying label to products as soon as possible, especially when there could be differences in the size, shape and/or quantity and/or quality of the product, the type of product and what it consists of, as well as different customers. As noted above, one common occurrence of such products can be found in metal processing facilities where the next I-Beam or metal coil may differ from the one that was previously produced.

Metal processing produces products that are hot as they come off a production line at temperatures of up to a 1000° C. (1832° F.). The labeling of such materials is conventionally done by riveting a tag on the hot metal, or, in the worst case waiting for them to cool down so that conventional manners of labelling can be done. Self-sticking labels have also been developed, such as FLEXcon's THERMLfilm UHT 10000 and THERMLfilm UHT 5000 label series sold by FLEXcon Company, Inc. of Spencer, Mass., with adhesives/substrates and print receptive coatings all designed to withstand high temperatures. The labels, while convenient, still require a human operator to get close to these hot metal substrates. In accordance with an embodiment, the invention provides a system that allows the label to be placed on hot metals while giving the operator the ability to maintain a safe distance from the hot metal.

There are additional challenges that are overcome in accordance with certain aspects of the invention as follows. Metals at 1000° C. (1832° F.) or even down to 350° C. (˜660° F.) present a problem with almost any adhesive, the first is that the adhesive must be mobile, i.e., tacky at least at the application temperature, but not overly tacky as in loss of cohesive strength. A second and perhaps the more difficult challenge is the possibility that the adhesive might ignite, which would char the adhesive leaving it with a poorer bond to the substrate, and may obscure any label. Even adhesives based on siloxanes (silicones) are subject to this phenomena, with the result that the surface of the adhesive develops silicates. One way to minimize this oxidation effect in accordance with an embodiment of the present invention is to minimize the exposure of the adhesive to oxygen. The surface roughness of the adhesive may also be reduced in accordance with an embodiment, by using a smooth release liner, for example a liner made on a polyester substrate, may help reduce pockets of entrapped air.

In accordance with an aspect, the label applicator is designed to minimize the open time from when the adhesive side of the label is exposed to the elevated temperatures of the hot metal and the time to complete the label contact to the hot surface, thus lowering the air (oxygen) exposure. In some circumstances the applicator may be equipped with vents from which a non-oxidizing fluid (e.g., gas) of nitrogen or carbon dioxide for example, could be directed over the hot substrate and the adhesive on the label, which would lower the oxygen concentration at the interface of the label and the hot metal.

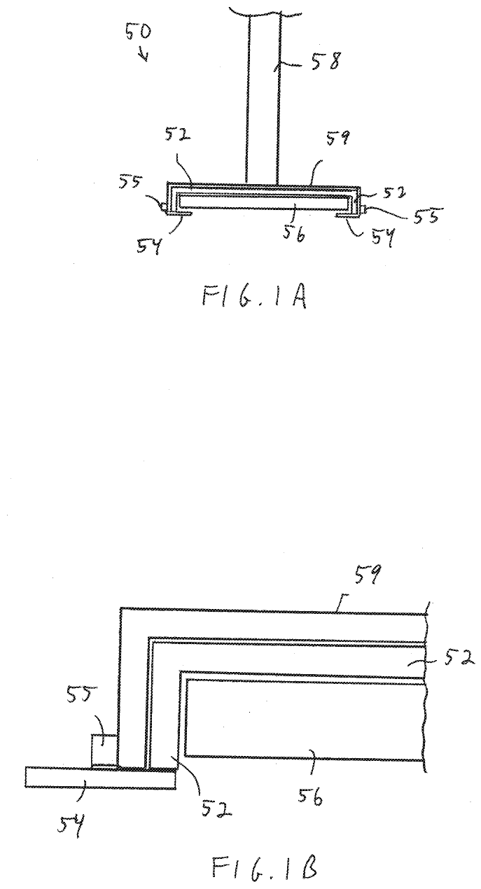

With reference to FIG. 1A, an application system 50 in accordance with an aspect of the invention includes an extension device 58 leading to a label holder 59, and along the interior of the label holder 59, a releasable inner layer 52 is provided that will be in contact with the printed side of the label. The primary purpose of this releasable layer 52 is to prevent the printed side of the label 56 from sticking to the applicator. The releasable layer may by composed of polytetrafluoroethylene (PTFE), perfluoroalkoxy (PFA) and fluorinated ethylene propylene (FEP) film or fabric reinforce PFTE, PFA or FEP film.

To keep the label in the applicator, one or more edge restraints 54 may also be provided. The edge restraints 54 may be on two sides, or may be along the entire edge or less than the entire edge, depending on the dimensions of the label. These restraints may have pneumatic hinges or actuators 55 that are able to hold the label in place, and then release the label at time of the label application as shown in FIG. 1B. The design of the pneumatic hinges or actuators 55 may be fine enough to enable the applicator to remove the label from the release liner, holding the label in place and then release the label when the label is applied. The adhesive side of the label 56 faces the open base of the applicator. Another variant of the release inner layer 52 may include a low-energy ceramic treatment.

For example, a high temperature label material such as THERMLfilm UHT (Ultra High Temp) 10000 or THERMLfilm UHT 5000 available from FLEXcon Company, Inc. of Spencer Mass., printed with the product identification information, with its release liner based on a PET film, may be mounted into the applicator with the printed side touching the low specific surface energy material covering the interior of the applicator, removing the liner so that the adhesive is facing out. The applicator may then bring the adhesive side of the label in contact with a hot metal product. The label is then transferred to the metal substrate.

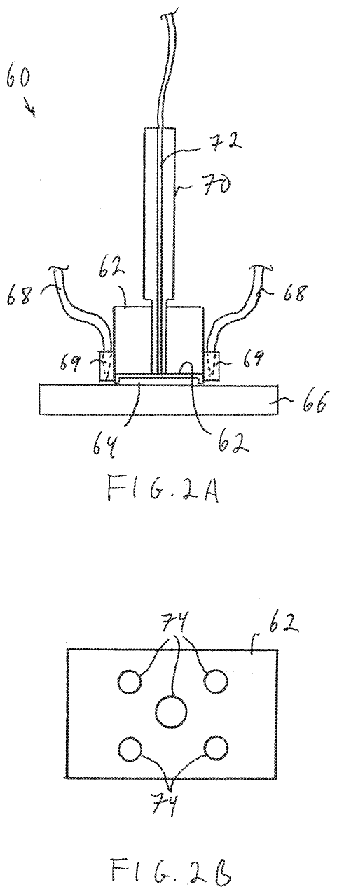

In accordance with further aspects and with reference to FIG. 2A, the system 60 may further include one or more sources of nitrogen gas that is delivered by nozzles 67 coupled to hoses 68 at the application site when the label 64 is applied to the hot substrate 66. Nitrogen gas may also be provided to the application site via channel 72 in the extension 70. The nitrogen gas will flood the area during application of the label, reducing the amount of combustible oxygen at the application site, and thereby reducing the likelihood of any combustion of any part of the label, including the adhesive.

In accordance with further aspects, the channel 72 in the extension 70 may provide a source of vacuum to the label 64 facilitating holding the label to the applicator, and later provide a positive pressure of nitrogen has when the label is being applied to the hot substrate. The inner surface of the label applicator 62 may include one or more apertures 74 through which the vacuum/nitrogen is provided to the application site as shown in FIG. 2B.

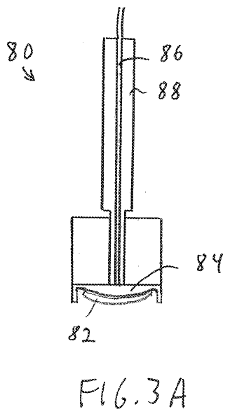

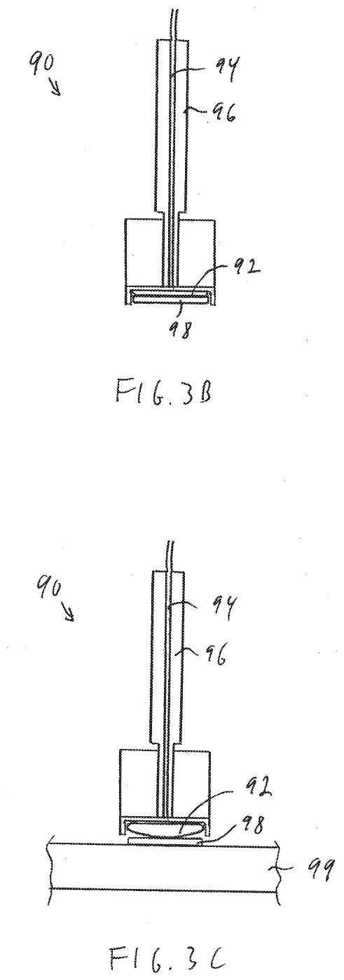

With reference to FIG. 3A, an application system 80 in accordance with another aspect includes a label 82 being held by a containment holder 84 as discussed above with reference to any of the previous aspects, but with a downward crown (somewhat exaggerated in the drawing to show the point) on the holder that imparts a downward curvature to the label 82 thus giving the applicator a single point of contact to initiate the label application. This reduces the chances of air entrapment. A vacuum and/or nitrogen line may also be provided via a channel 86 in the extension 88.

In accordance with further aspects and with reference to FIGS. 3B and 3C, the downward crown may be formed by an inflatable membrane 92 in a system as shown at 90. The inflatable membrane 92 may be activated by gas pressure delivered through a channel 94 the handle 96 to apply the label 98 to the hot substrate 99. In accordance with further aspects, the invention may involve placing the label in a downward crown, where the application head is formed of a flexible stainless steel that is able to curve around the curve of a roll, or lay flat to handle a sheet steel application.

Similarly, prior to placing the label in the applicator, the release liner is removed. The smoother the liner is, the smoother the adhesive may be, with fewer tiny areas of air entrapment may result. This leads to fewer chances of having the adhesive igniting when brought into contact with the hot metal because the amount of trapped oxygen is reduced. For this reason release liners based on polyester films are preferred in an aspect of the invention.

Another way in which oxygen may be minimized at the point of application, is to provide the applicator with vents 69, 74 along the label's adhesive surface (with reference again to FIG. 2A), and the vents 69, 74 could purge the surface of adhesive with nitrogen or other non-oxidizing gases, thus reducing even further the chance for adhesive combustion. Application of the label may also be facilitated by having the releasable inner layer be able to move by the application of force to the shaft, which could then return to its starting point by action of a spring or a compressed air action on a piston.

In accordance with another aspect, the invention involves employing a vacuum assist that is designed to hold the label in place (e.g., using the vacuum line of FIG. 2A), but that also provides a manner in which the label may be automatically removed from the liner or printer, then applied to the hot metal or other hot surface (e.g., via positive pressure of a nitrogen gas). A further variation of the label applicator in further aspects, involves providing holds across the releasable inner layer and have a gentle vacuum used to hold the label in place. At the point of application, the vacuum may be turned off and a positive pressure (again, e.g., nitrogen) may be provided to assist in placing the label on the hot surface.

In further aspects, rather than using hand dispensing units, devices of the invention may be used with automated programmable motion devices such as robots. In accordance with further aspects, an applicator made with various combinations of these properties, may further enhance operator safety and protect the label from an ignition. For example, the applicator as shown in FIGS. 2A and 2B, could well involve using the vents to purge the surface with a non-oxygen containing gas.

The applicator configuration chosen for any particular label application is dependent up the composition of the label, its stiffness, the adhesive (e.g., a heat activated adhesive could be preferred in certain higher temperature applications), and of course the temperature of the substrate to which the label is to be applied.

In accordance with various embodiments, the invention provides a label applicator for use in attaching a high temperature resistant label to substrates at temperatures up to 1000° C. The applicator includes a handle at one end to separate the person applying the label to the hot substrates, and at another end of the handle a containment area in which the label may be held with edge restraints. The containment area itself may be lined with a temperature resistant material with a low specific surface energy so that the printing on the label would not adhere to the containment area.

In accordance with further aspects, the temperature resistant, low specific surface energy material may be selected from the family of polytetrafluoroethylene or other fluoropolymers such as polytetrafluoroethylene (PTFE), perfluoroalkoxy (PFA) and fluorinated ethylene propylene (FEP), and in certain aspects, the fluoropolymer may include a reinforcing agent such as fiberglass scrim. The fiberglass reinforced fluoropolymer may include a membrane behind it that allows for the membrane to expand, permitting the label to make initial center contact to the hot metal.

In accordance with further aspects, the temperature resistant, low specific surface energy material may be a ceramic material, and the ceramic material may be annealed directly to the base metal in the label holding area. In accordance with further aspects, the label applicator may include vents at the point of application, and the vents may release a non-oxidizing gas so as to minimize the oxygen at the interface of the label and the hot substrate, and in certain embodiments, the non-oxidizing gas may be nitrogen. The invention also provides a label applicator that includes holes in the bottom of the label containment area from which a vacuum may be drawn to hold the label in place, then at the point of application to the hot surface the pressure could be reversed to assist in applying the label to the hot substrate in accordance with certain aspects.

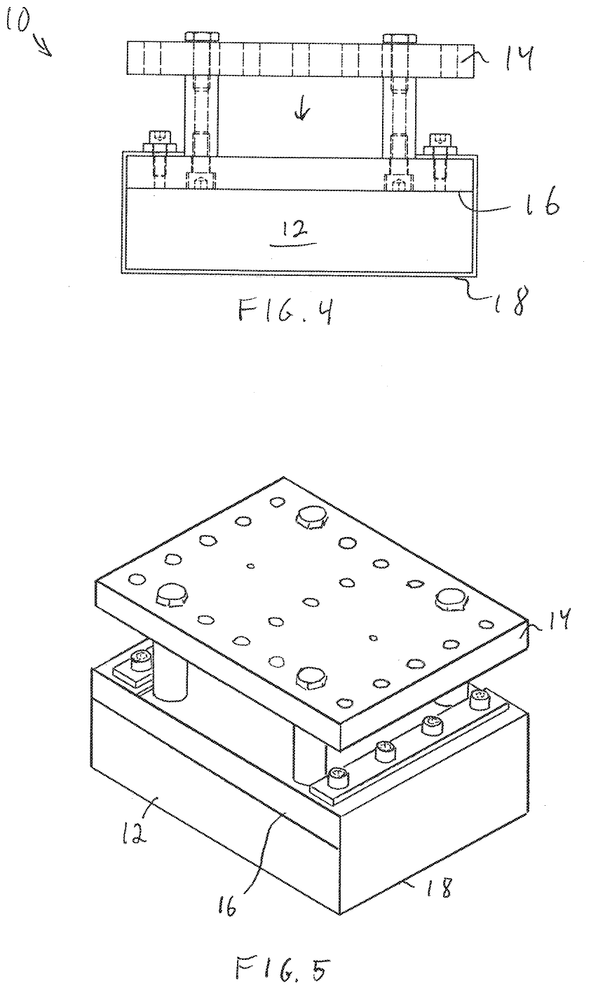

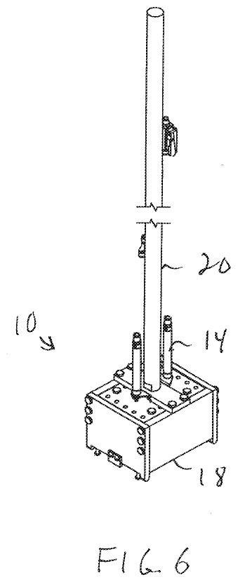

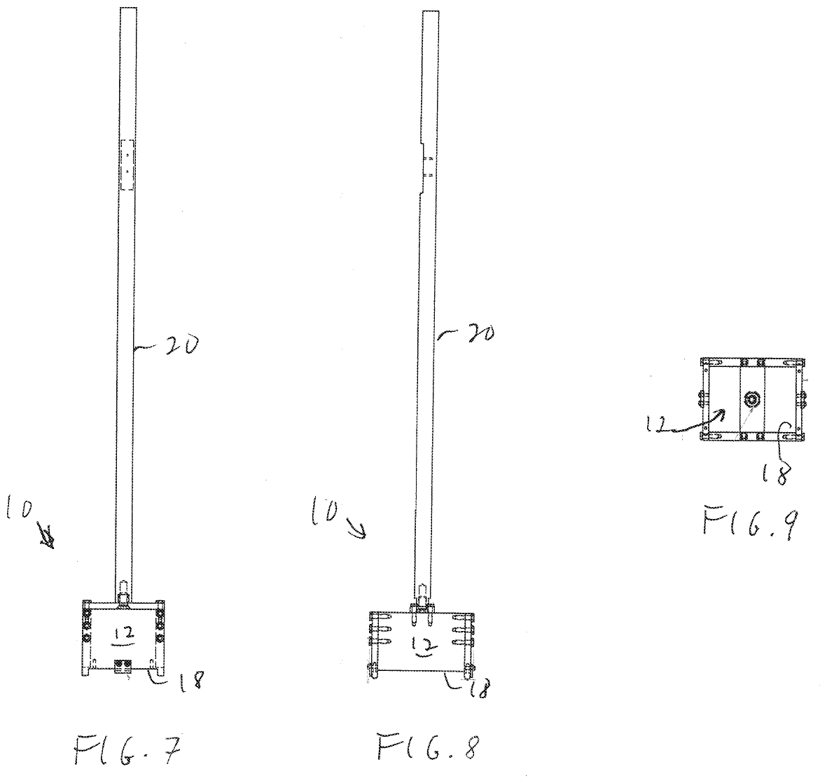

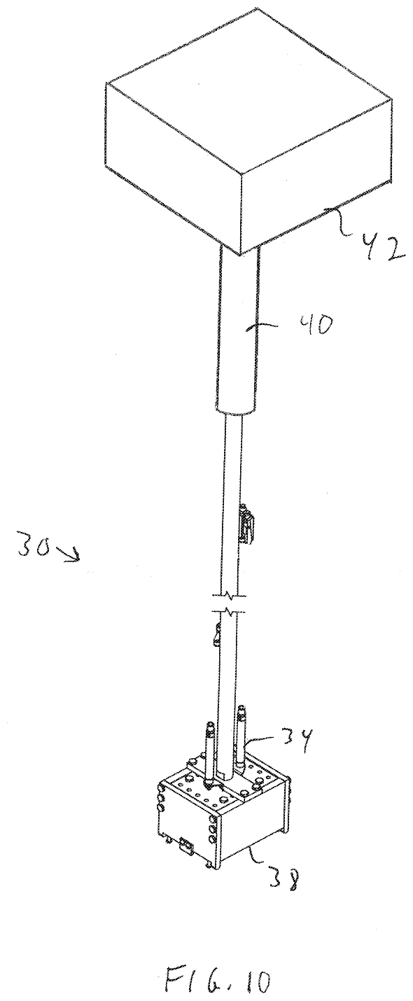

FIG. 4 shows a side sectional view of an applicator 10 that includes an interior label containment area 12, as well as the actuator portion 14 for urging the label toward a hot surface. With further reference to FIG. 5, as the actuator portion 14 is urged downward (in the drawing), a label on the inner surface 16 of the containment area 12 is moved toward the bottom 18 of the applicator 10. FIGS. 6-8 show further views of the applicator 10 that further include an extension device (e.g., a handle), and FIG. 9 shows a bottom view showing the containment area 12. FIG. 10 shows an applicator 30 in accordance with another embodiment of the present invention that includes an actuator portion 14 for urging a label through a containment area toward a bottom 38 as discussed above, and further includes an automated actuator 40 and control system 42 for automatically engaging the actuator portion 34.

Those skilled in the art will appreciate that numerous modifications and variations may be made to the above disclosed embodiments without departing from the spirit and scope of the present invention.

What is claimed is:

1. A label applicator for use in attaching a high temperature resistant label to substrates at temperatures of 350° C. to 1000° C., said label applicator comprising an extension member attached to a label containment area, said label containment area including at least one edge restraint for retaining the label and a backing area that includes a surface with a low specific energy that inhibits adhesion of a printed side of the label to the backing area of the containment area.

2. The label applicator as claimed in claim 1, wherein the low specific energy surface includes a fluoropolymer including any of polytetrafluoroethylene, perfluoroalkoxy and fluorinated ethylene propylene.

3. The label applicator as claimed in claim 2, wherein the fluoropolymer includes a reinforcing agent.

4. The label applicator as claimed in claim 3, wherein the reinforcing agent includes fiberglass scrim material.

5. The label applicator as claimed in claim 4, wherein the fiberglass scrim reinforced fluoropolymer includes a membrane that is expandable in a central portion of the containment area.

6. The label applicator as claimed in claim 1, wherein the low specific surface energy material includes ceramic material.

7. The label applicator as claimed in claim 6, wherein the ceramic material is annealed directly to a metal base of the label containment area.

8. The label applicator as claimed in claim 1, wherein the label applicator further includes vents for releasing a non-oxidizing fluid at the interface of the label and a hot substrate.

9. The label applicator as claimed in claim 8, wherein the non-oxidizing fluid is a nitrogen gas.

10. The label applicator as claimed in claim 1, wherein the label containment area includes at least one vacuum opening through which a vacuum may be provided to facilitate maintaining the label in the label containment area.

11. The label applicator as claimed in claim 10, wherein the at least one vacuum opening may be selectively coupled to a positive source of non-oxidizing gas pressure.

12. The label applicator as claimed in claim 11, wherein the positive source of non-oxidizing gas pressure includes nitrogen.

13. The label applicator as claimed in claim 11, wherein the positive source of non-oxidizing gas pressure includes carbon dioxide.

14. The label applicator as claimed in claim 1, wherein the backing area includes flexible stainless steel.

15. The label applicator as claimed in claim 1, wherein the backing area includes an inflatable membrane.

16. A label for use in the label applicator of claim 1.

17. A label applicator for use in attaching a high temperature resistant label to substrates at temperatures of at least 350° C., said label applicator comprising an extension member attached to a label containment area, said label containment area including least one vacuum opening through which a vacuum may be provided to facilitate maintaining the label in the label containment area and a backing area that includes a surface with a low specific energy that inhibits adhesion of a printed side of the label to the backing area of the containment area.

18. The label applicator as claimed in claim 17, wherein the low specific energy surface includes a fluoropolymer including any of polytetrafluoroethylene, perfluoroalkoxy and fluorinated ethylene propylene, as well as a fiberglass scrim material.

19. The label applicator as claimed in claim 17, wherein the label applicator further includes vents for releasing a non-oxidizing fluid at the interface of the label and a hot substrate.

20. A method of attaching a high temperature resistant label to substrates at a temperature of at least 350° C., said method including retaining the high temperature resistant label within a label containment area of a label applicator, extending the label applicator to a high temperature substrate, adhering the high temperature resistant label to the high temperature substrate, and releasing the high temperature label from the label applicator.
